(19) United States
(12) Patent Application Publication
(10) Pub. No.: US 2007/0217032 A1
(43) Pub. Date: Sep. 20, 2007

(54) Zoom lens device

(75) Inventors: Satoru Matsumoto, Saitama-shi (JP); Tetsuo Kamigaki, Saitama-shi (JP)

Correspondence Address: BIRCH STEWART KOLASCH & BIRCH, PO BOX 747, FALLS CHURCH, VA, 22040-0747, US

(73) Assignee: FUJINON CORPORATION

(21) Appl. No.: 11/724,270

(22) Filed: Mar. 15, 2007

(30) Foreign Application Priority Data
Mar. 15, 2006 (JP) P2006-071385

(51) Int. Cl. G02B 9/00

(52) U.S. Cl. 359/739

(57) ABSTRACT

When a cam barrel 24 is rotated on an outer periphery of a fixed barrel 23 during varying of power, a lens holding frame 22 that has cam followers 27, which engage with cam portions 29 provided in the cam barrel 24 and forward movement guide openings 28 provided in the fixed barrel 23, is moved straight forward in an optical axis direction by a cooperation between the cam portions 29 and the forward movement guide openings 28. A projection portion 30 is provided in an outer periphery of the diaphragm mechanism 15. A diaphragm aperture diameter is changed by rotating the projection portion 30 around an optical axis. The projection portion 30 engages with a diaphragm control cam member 31 fixed to an inner surface of the fixed barrel 23, and changes the diaphragm aperture diameter in response to movement of the lens holding frame 22.

### BACKGROUND OF THE INVENTION

1. Technical Field

The invention relates to a zoom lens device, which has a diaphragm mechanism built-in whose diaphragm aperture diameter is varied in response to variable power.

2. Description of the Related Art

A zoom lens device, which has built-in a diaphragm mechanism, is used in a camera and a projector. In some zoom lens devices, a brightness of the zoom lens is changed in response to variable power. In the case where such zoom lens device is utilized in an imaging system such as a camera, a diaphragm aperture diameter of the diaphragm mechanism is changed in response to variable power in order to keep an F-value, which is decided based on a subject brightness, constant at the time the power is varied (see JP Hei. 3-107132 A and JP 2000-352657 A).

In contrast, in the case where the zoom lens device is utilized in a projection system such as a projector, a diaphragm aperture of the diaphragm mechanism is changed to keep an illuminance on a screen surface substantially constant irrespective of a projection magnification of the zoom lens in such a way that when the zoom lens is set to high power, i.e., a high projection magnification (wide (WIDE) side), the diaphragm aperture is stopped down whereas when the zoom lens is set to low power, i.e., a low projection magnification (telescopic (TELE) side), the diaphragm aperture is opened (see JP Hei. 5-107503 A (corresponding to U.S. Pat. No. 5,361,107)).

Also, as the diaphragm mechanism incorporated into the zoom lens device, the following two types are known. One is that the diaphragm mechanism is fitted to a lens holding frame, which is moved in an optical axis direction at the time the power is varied, and is moved together with the lens holding frame (see JP 2001-235679 A (corresponding to U.S. Pat. No. 6,633,436)). The other is that the diaphragm mechanism is provided independently from lens groups, which are moved at the time when the power is varied, and is moved on a locus different from those of the lens groups (see JP 2005-84406 A (corresponding to U.S. Pat. No. 7,161,748) and JP 2005-84186 A).

As a structure of the diaphragm mechanism, for example, plural diaphragm blades are overlapped and held between a holding ring and a sliding plate so that the respective diaphragm blades are positioned swingably with respect to the holding ring and are also guided by the sliding plate via the guide holes. The aperture diameter is increased/lowered by swinging the sliding plate to swing the diaphragm blades along the guide holes (see JP Hei. 6-265972 A).

### SUMMARY OF THE INVENTION

In a zoom lens device according to an aspect of the invention, a diaphragm frame body which holds the diaphragm mechanism such that the projection portion is protruded to the outside and which is moved straight forward on an inside of the fixed barrel in the optical axis direction in varying the power, and a diaphragm control cam member which is provided fixedly on an inner surface of the fixed barrel and is always engaged with the projection portion in varying the power to move the projection portion around the optical axis in response to a movement of the diaphragm frame body are provided.

A zoom lens optical system is constructed by a plurality of lens groups, and also contains a plurality of moving lens groups which are moved in the optical axis direction in varying a power. A diaphragm frame body for holding a diaphragm mechanism may be fitted to a lens holding frame that holds one lens group out of the moving lens groups, or may be arranged independently such that the diaphragm frame body is moved in a different fashion from these moving lens groups.

A zoom lens device, in which the diaphragm mechanism is fitted integrally with a lens holding frame that holds the one lens group and the diaphragm mechanism is moved together with the lens holding frame in varying a power, may be constructed by providing a cam barrel rotatably on an outer periphery of the fixed barrel and rotating the cam barrel with respect to the fixed barrel in varying a power such that the lens holding frame is moved straight forward on an inside of the fixed barrel in the optical axis direction by a cooperation of the cam portions provided to the cam barrel and the forward movement guide openings provided to the fixed barrel. In this case, a diaphragm control cam member which has at least a length along which the projection portion engages with the diaphragm control cam member while the lens holding frame is moving in the optical axis direction, and has a displacement by which the projection portion is caused to move around the optical axis in response to a movement of the lens holding frame may be fixed to the inner surface of the fixed barrel.

This cam barrel is not limited to the cam barrel having cam portions that are used to move only the lens holding frame, to which the diaphragm mechanism is fitted, in the optical axis direction. For example, the cam barrel having a plurality of cam portions that are used to move a plurality of lens groups constituting all or a part of the zoom lens optical system in the optical axis direction may be employed.

According to the zoom lens device of the invention, the diaphragm frame body which holds the diaphragm mechanism such that the projection portion is protruded to the outside and which is moved straight forward on the inside of the fixed barrel in the optical axis direction in varying the power, and the diaphragm control cam member which is provided fixedly on the inner surface of the fixed barrel and is always engaged with the projection portion in varying the power to move the projection portion around the optical axis in response to a movement of the diaphragm frame body are provided. Therefore, there is no need to provide the diaphragm controlling cam in the cam barrel, or the like, and thus a reduction in size of the zoom lens device can be achieved.

Also, according to another invention in which the lens holding frame is moved by rotating the cam barrel outside the fixed barrel, it is not required to increase an amount of rotation of the projection portion even though an amount of rotation of the cam barrel is increased. Therefore, strength of the sliding plate of the diaphragm mechanism can be maintained, and also there is no need to provide the diaphragm controlling cam portions in the cam barrel. As a result, a reduction in size of the zoom lens device can be achieved.

### BRIEF DESCRIPTION OF THE DRAWINGS

FIG. 1 is an explanatory view showing the configuration of a projector using a zoom lens barrel, the upper portion of FIG. 1 shows a state at the WIDE end, and the lower portion of FIG. 1 shows a state at the TELE end.

FIG. 2 is a section view showing a main portion of the zoom lens barrel taken along an optical axis.

FIG. 3 is a section view, which is perpendicular to the optical axis, which shows the main portion of the zoom lens barrel and which shows a state where a diaphragm mechanism has the smallest diameter of a diaphragm aperture at the WIDE end.

FIG. 4 is a section view, which is perpendicular to the optical axis, which shows the main portion of the zoom lens barrel, and which shows a state where the diaphragm mechanism has a full diameter of the diaphragm aperture at the TELE end.

FIG. 5 is an exploded perspective view showing the configuration of the diaphragm mechanism.

FIG. 6 is an explanatory view showing a state of diaphragm blades at the WIDE end.

FIG. 7 is an explanatory view showing a state of the diaphragm blades at the TELE end.

### DETAILED DESCRIPTION OF EMBODIMENTS OF THE INVENTION

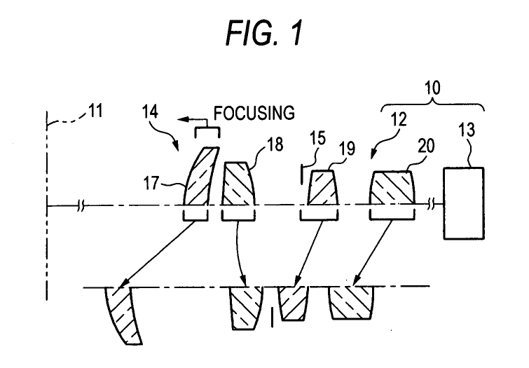

As shown in FIG. 1, a projector 10 is a projection type projector for projecting image light on a screen 11. The projector 10 includes a zoom lens device 12 and an image light generating portion 13. The image light generating portion 13 generates the image light by receiving and optically modulating an illumination light, which is emitted from a light source and whose energy distribution is uniformed by a light guiding device such as a rod integrator. The zoom lens device 12 includes a zoom lens optical system 14 and a diaphragm mechanism 15. The zoom lens device 12 projects the image light generated by the image light generating portion 13 on the screen 11. In this projector 10, a zooming motor is driven in response to user's operation of a zoom lever or a zoom button provided on the outer portion. Then, a power of the zoom lens optical system 14 is varied between a WIDE end (the high power side on which a projection magnification is large) and a TELE end (the low power side on which a projection magnification is small) by utilizing such driving to adjust a size of the projection screen. In this case, a screen size projected onto the screen 11 is increased when the projector 10 is set to the WIDE end whereas the screen size is decreased when the projector 10 is set to the TELE end.

The zoom lens optical system 14 has a four-group lens configuration of the front-cell focusing type, for example. Respective lens groups 17 to 20 are moved in the optical axis direction. The diaphragm mechanism 15 is built in between the lens group 18, which is the second lens group from the screen 11 side, and the lens group 19. The diaphragm mechanism 15 is moved together with the lens group 19, and corrects a light quantity so that the diaphragm aperture diameter is opened gradually from a small aperture diameter to a full aperture diameter when power is varied continuously from the WIDE end to the TELE end. This diaphragm corrects the light quantity by means of the pupil type diaphragm.

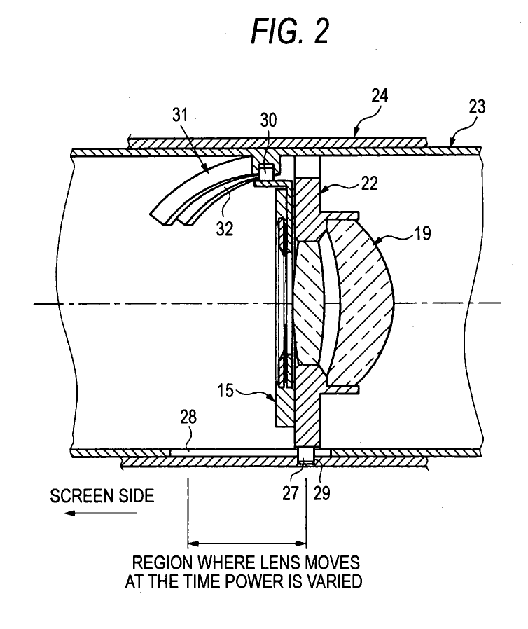

As shown in FIG. 2, the lens group 19 is held by a lens holding frame 22. The diaphragm mechanism 15 is attached to the lens holding frame 22 on the screen 11 side. A fixed barrel 23 is provided on an outer periphery of the lens holding frame 22. A cam barrel 24 is provided on an outer periphery of the fixed barrel 23.

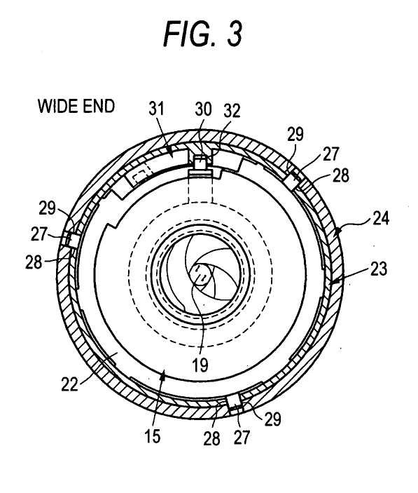

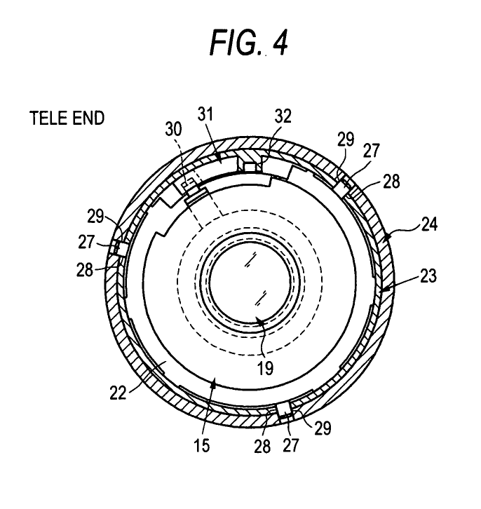

As shown in FIGS. 3 and 4 in detail, cam followers 27 are provided in tripartition positions on the outer periphery of the lens holding frame 22 to protrude. Each cam follower 27 engages with a corresponding forward movement guide opening 28 provided in the fixed barrel 23 and with a cam face of a corresponding cam portion 29 provided in the cam barrel 24. When receiving a driving force of the zoom motor, the cam barrel 24 is rotated around the outer periphery of the fixed barrel 23 about the optical axis. When the cam barrel 24 is rotated, each cam followers 27 follow up an intersection point between the cam face of the corresponding cam portion 29 and the corresponding forward movement guide opening 28 and thereby, the lens holding frame 22 is moved in the optical axis direction in a straight forward manner.

Also, plural cam portions for moving the other lens groups in the optical axis direction are provided in the cam barrel 24. In this case, the forward movement guide openings, which guide the other lens groups in the optical axis direction, may be provided in the fixed barrel 23. Alternatively, the forward movement guide openings 28 provided in the fixed barrel 23 may also be used as forward movement guide openings, which guides the other lens groups in the optical axis direction.

A projection portion 30 protrudes from an outer periphery of the diaphragm mechanism 15. The projection portion 30 can rotate about the optical axis in the circumferential direction. A diaphragm aperture diameter of the diaphragm mechanism 15 is changed by rotating the projection portion 30 around the optical axis. A top end of this projection portion 30 engages with a diaphragm control cam member 31 provided on an inner periphery of the fixed barrel 23. The diaphragm control cam member 31 is formed with a recess portion 32 having a pair of cam faces, which hold opposing portions of the outer periphery of the projection portion 30 therebetween. The cam face of the recess portion 32 is formed to allow the projection portion 30 to rotate about the optical axis in response to the movement of the lens holding frame 22 in the optical axis direction. Specifically, base ends (the opposite-side ends to the screen 11) of the pair of cam faces of the recess portion 32 is located at a position where the recess portion 32 is drawn with a solid line in FIGS. 3 and 4. Also, tip ends of the cam faces of the recess portion 32 (the screen-side end) is located at a position where the recess portion 32 is drawn with a dashed line in FIGS. 3 and 4. That is, in this case, the cam faces of the recess portion 32 don't extend parallel to the optical axis. The cam faces of the recess portion 32 extends from the base ends to the tip ends so as to allow the projection portion 31 disposed between the cam faces of the recess portion 32 to rotate about the optical axis when the lens holding frame 22 moves in the optical axis direction. It is noted that a part of the cam faces of the recess portion 32 may extend in parallel to the optical axis.

The diaphragm control cam member 31 may be formed integrally with the fixed barrel 23. Alternatively, screws may be screwed in from the outer periphery of the fixed barrel 23 so as to fix the diaphragm control cam member 31, which is formed independently from the fixed barrel 23, to the inner periphery of the fixed barrel 23. If the diaphragm control cam member 31 is fixed with the screw as in the latter case, a fitting position of the diaphragm control cam member 31 can be adjusted with respect to the fixed barrel 23. Also, an engaging mode between the projection portion 30 and the diaphragm control cam member 31 is not limited to the above concave/convex fitting mode in which the projection portion 30 is shaped into a pin shape and the counter part is shaped into the recess portion 32. Instead of the recess portion 32, such a mode may be employed that the projection portion 30 is formed to have a Y-shaped fork portion and the counter part is shaped into the rail portions, which put the fork portion.

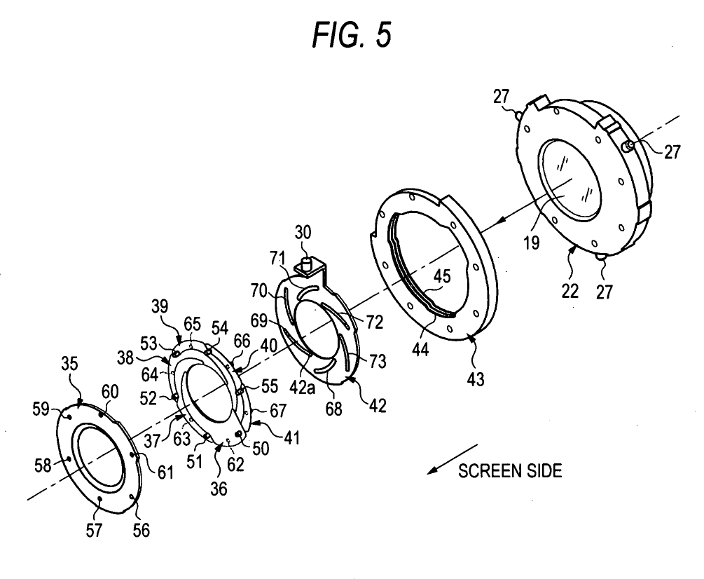

As shown in FIG. 5, the diaphragm mechanism 15 includes a holding ring 35, plural diaphragm blades 36 to 41, and a sliding plate 42. These members are held by a diaphragm frame body 43. The holding ring 35, the sliding plate 42, and the diaphragm frame body 43 are formed into a donut shape. A pair of grooves 44, 45 are formed in the inner periphery of the diaphragm frame body 43 at a predetermined interval. The holding ring 35 and the sliding plate 42 are fitted into the grooves 44 and 45 from the screen 11 side and the opposite side, respectively. When incorporated into the groove 44 of the diaphragm frame body 43, the holding ring 35 is held so as not to rotate. In contrast, when incorporated into the other groove 45, the sliding plate 42 is held so as to be rotatable. The plural diaphragm blades 36 to 41 are overlapped mutually between the holding ring 35 and the sliding plate 42 so as not to interfere with each other and incorporated into the diaphragm frame body 43. The diaphragm frame body 43 is fixed to the lens holding frame 22 by a fixing member such as a screwing. Here, the above projection portion 30 is provided in an outer periphery of the sliding plate 42 to protrude.

Pivot pins 50 to 55 are provided upright on base end portions of the diaphragm blades 36 to 41. These pivot pins 50 to 55 are fitted rotatably into bearing holes 56 to 61 formed in the holding ring 35. The diaphragm blades 36 to 41 are disposed on the holding ring 35 so as to be swingable. Also, nib pins 62 to 67 are provided upright on the opposite surfaces, on which the pivot pins 50 to 55 are formed, of the diaphragm blades 36 to 41. These nib pins 62 to 67 engage with longitudinal guide holes 68 to 73 formed in the sliding plate 42.

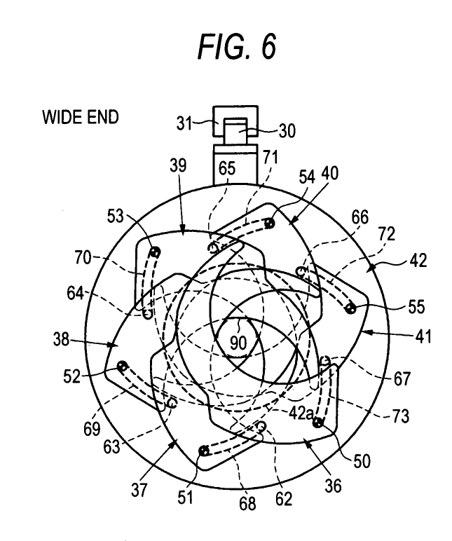

As shown in FIG. 6, when the zoom lens device 12 is located at the WIDE end, the diaphragm control cam member 31 causes the projection portion 30 to locate upward with respect to the circumference of the optical axis. Therefore, when the sliding plate 42 comes to this rotation position, top ends of the diaphragm blades 36 to 41 are moved to protrude from openings 42a formed in the sliding plate 42. Accordingly, a diaphragm aperture diameter 90 of the diaphragm mechanism 15 at the WIDE end is set to the minimum diaphragm aperture diameter defined by the diaphragm blades 36 to 41.

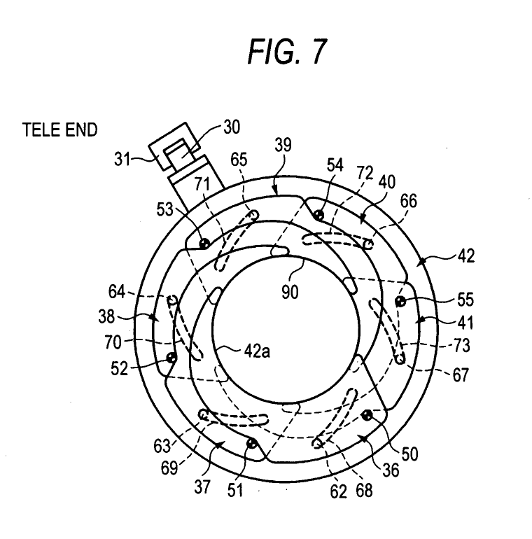

As shown in FIG. 7, when a power of the zoom lens device 12 is varied from the WIDE end to the TELE end, the diaphragm mechanism 15 as well as the lens holding frame 22 is moved to the screen 11 side. Then, the projection portion 30 is moved around the optical axis in response to the movement of the diaphragm control cam member 31. The sliding plate 42 rotates anticlockwise about the optical axis. According to the rotation of the sliding plate 42, the nib pins 62 to 67 on the diaphragm blades 36 to 41 are moved along the longitudinal guide holes 68 to 73, respectively and the diaphragm blades 36 to 41 are swung about the pivot pins 50 to 55 serving as pivots in the direction along which their top ends go away from the optical axis. Accordingly, the diaphragm aperture diameter 90 can be released (increased) continuously. Also, the diaphragm aperture diameter 90 at the TELE end corresponds to the full aperture diameter, and is defined by the diaphragm aperture diameter. The full aperture diameter is slightly smaller than the opening 42a formed in the sliding plate 42. In this case, the full aperture diameter may be determined by the opening 42a after the diaphragm blades 36 to 41 are retreated from the opening 42a. Also, since the six diaphragm blades 36 to 41 are used in the diaphragm mechanism 15 of this embodiment, a light quantity can be corrected by the pupil type diaphragm aperture diameter.

The diaphragm control cam member 31 of this embodiment is fixed to the inner surface of the fixed cam 23, and can move the projection portion 30 around the optical axis in response to the movement of the lens holding frame 22 with respect to the fixed barrel 23 in the optical axis direction. Therefore, how the recess portion 32 of the diaphragm control cam member 31 extends with respect to the optical axis can be designed freely in response to the variable power. For example, as described above, the aperture diameter may be changed continuously from the minimum diaphragm aperture diameter to the full aperture diameter when a power of the zoom lens barrel 12 is varied from the WIDE end to the TELE end. Alternatively, the aperture diameter may be changed continuously from the minimum diaphragm aperture diameter to the full aperture diameter, when a power of the zoom lens barrel 12 is varied in the reverse way. Further alternatively, the diaphragm aperture diameter may be varied only in a particular power range, and the particular diaphragm aperture diameter may be kept in the other power varying ranges. In addition, since a rotation amount of the sliding plate 42 can be kept constant irrespective of a rotation amount of the cam barrel 24, a rotation amount of the sliding plate 42 rotated between the full aperture diameter and the minimum diaphragm aperture diameter can be reduced. As a result, it is not necessary to process the guide holes 68 to 73 to be long. Thus, a reduction in size of the diaphragm mechanism 15 can be achieved. In addition, since the length of the longitudinal guide holes 68 to 73 can be shortened, the strength of the sliding plate 42 can be increased.

In the above embodiment, description has been given on the four-group zoom lens optical system. However, any optical system may be employed so long as the optical system is configured by two lens groups, or more. Also, in the above embodiment, the diaphragm mechanism is moved together with the third lens group. However, the moving lens is not limited to the third lens group. Any lens group may be employed so long as the lens group can be moved in the optical axis direction during the varying of power.

Also, in the above embodiment, the diaphragm mechanism 15 is attached to the lens holding frame 22. However, the invention is not limited thereto. The holding frame for holding the diaphragm mechanism may be arranged independently from the lens groups, which are moved at the time the power is varied, and may be configured to move on a locus different from those of these lens groups. In this case, in addition to the cam portions for moving the lens holding frame, the cam portion for moving the holding frame may be provided in the cam barrel.

In the above embodiment, only the zoom lens device 12 having the built-in diaphragm for use in the projector 10 is described. However, the invention is not limited thereto. Also, the invention can be applied to an optical equipment such as a photo camera, an electronic camera and a copying machine.

What is claimed is:

1. A zoom lens device comprising:
a lens group that constitutes a part of a zoom lens optical system and moves in an optical axis direction during varying of power of the zoom lens with being inside a fixed barrel;
a diaphragm mechanism disposed in front of or in rear of the one lens group in the optical axis direction, wherein a diaphragm aperture diameter of the diaphragm mechanism is changed by moving a projection portion, which protrudes to an outside, around an optical axis;
a diaphragm frame body, which holds the diaphragm mechanism so that the projection portion protrudes to the outside and which moves straight forward in the optical axis direction during the varying of the power with being inside the fixed barrel; and
a diaphragm control cam member, which is fixed to an inner surface of the fixed barrel, which always engages with the projection portion during the varying of the power and which moves the projection portion around the optical axis in response to the movement of the diaphragm frame body.

2. The device according to claim 1, wherein the diaphragm frame body holds the lens group together with the diaphragm mechanism.

3. A zoom lens device comprising:
a lens holding frame that holds a lens group constituting a part of a zoom lens optical system;
a fixed barrel formed with forward movement guide openings, which engage with cam followers provided in the lens holding frame to guide the lens holding frame in an optical axis direction;
a cam barrel that is held on an outer periphery of the fixed barrel so as to be rotatable, the cam barrel that comprises cam portions, which engage with the respective cam followers and which are used to move the lens holding frame in the optical axis direction, wherein when the cam barrel is rotated with respect to the fixed barrel during varying of a power of the zoom lens, the lens holding frame is moved straight forward in the optical axis direction by cooperation between the cam portions and the forward movement guide openings with the lens holding frame being inside the fixed barrel;
a diaphragm mechanism, which is disposed in front of or in rear of the lens holding frame in the optical axis direction, which is moved along with the lens holding frame during the varying of the power, and which comprises a projection portion protruding to an inner surface of the fixed barrel, wherein a diaphragm aperture diameter of the diaphragm mechanism is changed by moving the projection portion around an optical axis; and
a diaphragm control cam member, which is fixed to the inner surface of the fixed barrel, which has at least such a length that the projection portion engages with the diaphragm control cam member at least during a period in which the lens holding frame moves in the optical axis direction, and which moves the projection portion around the optical axis in response to the movement of the lens holding frame.

4. A zoom lens device comprising:
a plurality of lens groups that constitute all or a part of a zoom lens optical system;
a fixed barrel that supports the lens groups movably inside the fixed barrel, the fixed barrel comprising forward movement guide portions that engage with respective cam followers provided in the respective lens groups;
a cam barrel that is held on an outer periphery of the fixed barrel so as to be rotatable, the cam barrel comprising a plurality of cam portions that engage with the respective cam followers to move the respective lens groups in the optical axis direction;
a diaphragm mechanism, which is disposed in front of or in rear of one lens holding frame that holds one of the plurality of lens groups in the optical axis direction and which is moved together with the lens holding frame, wherein a diaphragm aperture diameter of the diaphragm mechanism is changed by moving a projection portion, which protrudes to an inner surface of the fixed barrel, around an optical axis; and
a diaphragm control cam member, which is fixed to the inner surface of the fixed barrel, which has at least such a length that the projection portion engages with the diaphragm control cam member at least during a period in which the lens holding frame moves in the optical axis direction, and which moves the projection portion around the optical axis in response to the movement of the lens holding frame.
